(19) United States
(12) Patent Application Publication
(10) Pub. No.: US 2024/0175295 A1
(43) Pub. Date: May 30, 2024

(54) ELECTRONIC DOOR LOCK AND METHOD FOR AUTOMATICALLY JUDGING LOCKING/UNLOCKING DIRECTIONS THEREOF

(71) Applicant: Primax Electronics Ltd., Taipei (TW)

(72) Inventors: Kuan-Po Huang, Taipei (TW); Wen-Hann Tsai, Taipei (TW); Tung-Yu Lai, Taipei (TW)

(21) Appl. No.: 18/093,211

(22) Filed: Jan. 4, 2023

(30) Foreign Application Priority Data
Nov. 29, 2022 (TW) 111145741

(51) Int. Cl. E05B 47/00

(52) U.S. Cl. CPC E05B 47/0012; E05B 2047/0017; E05B 2047/0068; E05B 2047/0069; E05B 65/00

(57) ABSTRACT

An electronic door lock and a method for automatically judging a locking/unlocking direction of the electronic door lock are provided. The electronic door lock includes a latch assembly, a lock body, a transmission rod, a locking detection module, a motor module and a motion detection circuit board. The transmission rod is connected with the latch assembly for controlling the latch assembly. The motion detection circuit board is electrically connected with the motor module and the locking detection module. The motion detection circuit board controls the motor module to drive the transmission rod. Consequently, a latch bolt of the latch assembly is protruded out in a first direction or a second direction. By detecting the status of the transmission rod, the locking detection module judges whether the latch bolt is protruded to a locking position.

### FIELD OF THE INVENTION

The present invention relates to an electronic door lock, and more particularly to an electronic door lock with the function of judging the locking/unlocking directions.

### BACKGROUND OF THE INVENTION

With the advancement of modern science and technology, smart home appliances are gradually and widely used in home life. The uses of the smart home appliances make home life more comfortable and convenient. Among many types of smart home appliances, an electronic door lock is usually one of the standard equipment. Generally, the electronically controlled locking state of the electronic door lock is released through the password of the user's input, the fingerprint recognition, the facial feature recognition, and so on. In addition, a built-in drive motor module of the electronic door lock is enabled to automatically perform the process of locking or unlocking the latch bolt.

Generally, depending on the opening directions, the door panels are designed according to the two specifications. That is, the first type door panels are open to the left, and the second type door panels are open to the right. When the electronic door lock is installed for the first time, it is necessary for the electronic door lock to obtain the information about the opening direction of the door panel. According to the information about the opening direction of the door panel, the latch bolt of the electronic door lock can be protruded in the correct direction to achieve the locking purpose. However, the existing electronic door locks usually have no functions of automatically judging the locking direction.

In order to overcome the drawbacks of the conventional technologies, it is important to provide an electronic door lock with the function of judging the locking/unlocking directions.

### SUMMARY OF THE INVENTION

The present invention provides an electronic door lock with the function of judging the locking/unlocking directions.

In accordance with an aspect of the present invention, an electronic door lock is provided. The electronic door lock is installed on a door panel. The electronic door lock includes a latch assembly, a lock body, a transmission rod, a locking detection module, a motor module and a motion detection circuit board. The latch assembly includes a latch bolt. The transmission rod is disposed within the lock body and connected with the latch assembly. The transmission rod includes a first protruded edge and a second protruded edge. The locking detection module includes a first locking detection unit and a second locking detection unit corresponding to the first protruded edge and the second protruded edge. The motor module is installed in the lock body. The transmission rod is driven by the motor module. The motion detection circuit board is electrically connected with the motor module and the locking detection module. When the latch bolt is completely received within the latch assembly, the first protruded edge is contacted with the second locking detection unit. When the motion detection circuit board controls the motor module to drive rotation of the transmission rod and the latch bolt is correspondingly protruded out from the latch assembly to a locking position, the first protruded edge is detached from the second locking detection unit, and the first protruded edge or the second protruded edge is correspondingly moved and then contacted with the first locking detection unit. The motion detection circuit board confirms that the latch bolt has been protruded out from the latch assembly according to a detection result of the locking detection module.

In an embodiment, the locking detection module is a micro switch module.

In an embodiment, the electronic door lock further includes a geomagnetic sensing unit, and an opening direction and a closing direction of the door panel are detected by the geomagnetic sensing unit.

In an embodiment, the lock body includes an operating element, and the operating element is installed on a surface of the lock body and linked with the transmission rod

In accordance with another aspect of the present invention, a method for automatically judging a locking/unlocking direction of an electronic door lock is provided. The electronic door lock is installed on a door panel. The method includes the following steps. In a step (A), a motor module is controlled to drive a movement of a latch bolt in a first direction. Then, a step (B) is performed to judge whether an operating time of the motor module in the first direction is within a predetermined time period. If a judging condition of the step (B) is not satisfied, a step (C) is performed. If the judging condition of the step (B) is satisfied, a step (E) is performed. In the step (C), the motor module is controlled to drive the movement of the latch bolt in a second direction. The step (D) is performed to judge whether an operating time of the motor module in the second direction is within the predetermined time period. If a judging condition of the step (D) is not satisfied, a step (G) is performed. If the judging condition of the step (D) is satisfied, the step (E) is performed. A step (E) is performed to judge whether the latch bolt is protruded to a locking position. If a judging condition of the step (E) is not satisfied, the step (G) is performed. If the judging condition of the step (E) is satisfied, a step (F) is performed. In the step (F), a locking direction record is generated. In the step (G), an erroneous message is reported.

In an embodiment, the electronic door lock further includes a geomagnetic sensing unit, and a change of a Y-axis coordinate value of the door panel is detected by the geomagnetic sensing unit. The method further includes a process of judging a door opening direction. The process of judging the door opening direction includes the following steps. In a step (H), the locking direction record is read. If the locking direction record indicates that the electronic door lock is locked in the first direction, a step (I) is performed. If the locking direction record indicates that the electronic door lock is locked in the second direction, a step (J) is performed. In the step (I), the electronic door lock is unlocked from the first direction. In the step (J), the electronic door lock is unlocked from the second direction. Then, a step (K) is performed to judge whether the Y-axis coordinate value is increased or decreased when the door panel is swung. If the Y-axis coordinate value is decreased, a step (L) is performed. If the Y-axis coordinate value is decreased, a step (M) is performed. The step (L) is performed to confirm that the door panel is opened inwards and closed outwards. The step (M) is performed to confirm that the door panel is opened outwards and closed inwards.

Preferably, in the step (B) and the step (D), the predetermined time period is in the range between 3 seconds and 7 seconds.

From the above descriptions, the present invention provides the electronic door lock. When compared with the conventional technologies, the latch bolt in the electronic door lock of the present invention can be driven to be moved in two different directions. Consequently, the electronic door lock is suitably applied to the door panel opened/closed to the left side or the door panel opened/closed to the right side. Furthermore, the geomagnetic sensing unit installed on the electronic door lock or the door panel is used to detect the opening/closing direction of the door panel in order to prompt the user of the opening/closing direction of the door panel.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A schematically illustrates an electronic door lock according to an embodiment of the present invention, in which a latch bolt of the electronic door lock is permitted to be protruded in a first direction;

FIG. 1B is a schematic system block diagram illustrating the architecture of the electronic door lock according to the embodiment of the present invention;

FIG. 1C schematically illustrates the operation of a locking detection module of the electronic door lock as shown in FIG. 1A;

FIG. 2A schematically illustrates the electronic door lock according to the embodiment of the present invention, in which the latch bolt of the electronic door lock is permitted to be protruded in a second direction;

FIG. 2B schematically illustrates the operation of the locking detection module of the electronic door lock as shown in FIG. 2A;

FIG. 3 is a flowchart illustrating a method of locking and unlocking an electronic door lock according to an embodiment of the present invention;

FIGS. 4A and 4B are schematic top views illustrating the operations of the geomagnetic sensing unit in the electronic door lock when the door panel is opened or closed; and

FIG. 5 is a flowchart illustrating a method of judging the door opening direction by using the electronic door lock of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

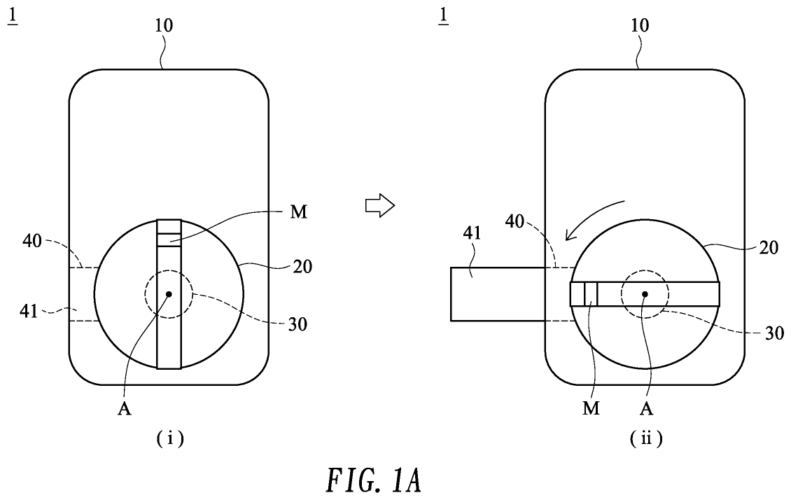

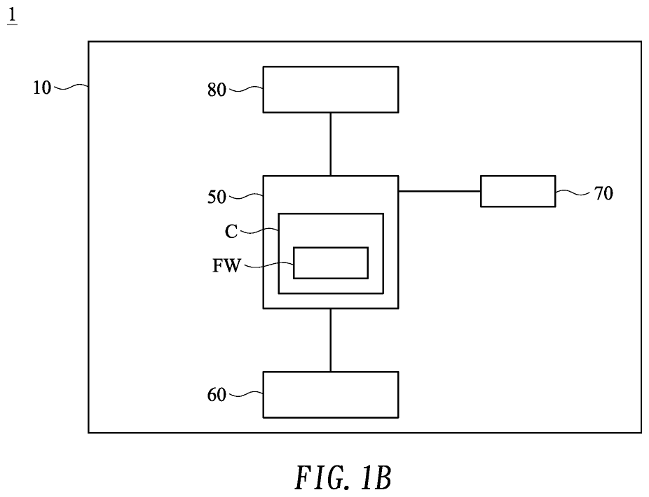

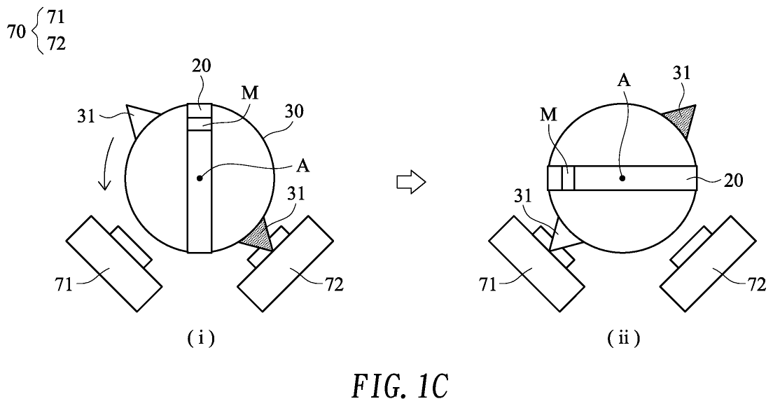

Please refer to FIGS. 1A, 1B and IC. FIG. 1A schematically illustrates an electronic door lock according to an embodiment of the present invention, in which a latch bolt of the electronic door lock is permitted to be protruded in a first direction. FIG. 1B is a schematic system block diagram illustrating the architecture of the electronic door lock according to the embodiment of the present invention. FIG. 1C schematically illustrates the operation of a locking detection module of the electronic door lock as shown in FIG. 1A.

The electronic door lock 1 can be installed on a door panel (not shown). The components of the electronic door lock 1 may be divided into fastening components and electronic control components. The fastening components include a lock body 10, an operating element 20, a transmission rod 30 and a latch assembly 40. The electronic control components includes a motion detection circuit board 50, a motor module 60, a locking detection module 70 and a geomagnetic sensing unit 80.

The latch assembly 40 is located inside the lock body 10 or located outside the lock body 10. The latch assembly 40 comprises a latch bolt 41. The latch bolt 41 can be received within the latch assembly 40.

The transmission rod 30 is pivotally arranged in the lock body 10. In addition, a rotation axis A can be defined by the transmission rod 30. A first end of the transmission rod 30 is connected with the latch assembly 40. The latch bolt 41 can be selectively protruded out from the latch assembly 40 or retracted back into the latch assembly 40 through the operation of the transmission rod 30. Moreover, as shown in FIG. 1C, the transmission rod 30 is equipped with two protruded edges 31 in the radial direction. The two protruded edges 31 are opposed to each other.

The operating element 20 is installed on the surface of the lock body 10. In addition, the operating element 20 is connected with a second end of the transmission rod 30. The first end of the transmission rod 30 connected with the latch assembly 40 and the second end of the transmission rod 30 connected with the operating element 20 are opposed to each other. The operating element 20 is linked with the transmission rod 30. In this embodiment, the operating element 20 has a knob structure. Moreover, a rotation mark M is formed on the operating element 20.

The motion detection circuit board 50 is electrically connected with the motor module 60, the locking detection module 70 and the geomagnetic sensing unit 80.

The motor module 60 is installed on the lock body 10. The transmission rod 30 can be driven by the motor module 60.

The locking detection module 70 comprises a first locking detection unit 71 and a second locking detection unit 72. The locking detection module 70 is located beside the transmission rod 30. Moreover, the first locking detection unit 71 and the second locking detection unit 72 correspond to the two protruded edges 31. For example, the locking detection module 70 is a micro switch module.

The geomagnetic sensing unit 80 is installed on the lock body 10 or the door panel (not shown). The geomagnetic sensing unit 80 is used for detecting the change of the Y-axis coordinate value when the door panel is swung. An example of the geomagnetic sensing unit 80 includes but is not limited to a LSM303AH geomagnetic sensor from STMicroelectronics.

The motion detection circuit board 50 comprises a control circuit C. The control circuit C contains a firmware FW. The motion detection circuit board 50 can control the operating time and the rotating direction of the motor module 60 according to the feedback signal detected by the locking detection module 70 through the programming language of the firmware FW. Furthermore, the motion detection circuit board 50 detects the opening/closing direction of the door panel according to the feedback signal detected by the geomagnetic sensing unit 80, and the motion detection circuit board 50 prompts the user of the opening/closing direction of the door panel.

Please refer to FIGS. 1A and 1C. For illustration, only the knob structure with the rotation mark M of the operating element 20, the transmission rod 30 and the locking detection module 70 beside the transmission rod 30 are shown in FIG. 1C. In case that the operating element 20 is in a vertical state, the second locking detection unit 72 of the locking detection module 70 is pressed by the protruded edge 31 at the right side of the transmission rod 30. Moreover, as shown in FIG. 1C (i), the rotation mark M on the operating element 20 is located at the 12 o'clock position. Under this circumstance, the first locking detection unit 71 and the second locking detection unit 72 of the locking detection module 70 generate detection signals “0” and “1”, respectively. After the motion detection circuit board 50 receives the detection signals “0” and “1”, the motion detection circuit board 50 judges that the latch bolt 41 is completely received within the latch assembly 40 (see FIG. 1A(i)).

Then, the operating element 20 is manually rotated by the user, or the transmission rod 30 is driven by the motor module 60. Consequently, the operating element 20 is rotated about the rotation axis A in the counterclockwise direction. Consequently, as shown in FIG. 1C (ii), the rotation mark M on the operating element 20 is rotated to the 9 o'clock position. Under this circumstance, the protruded edge 31 originally contacted with the second locking detection unit 72 is detached from the second locking detection unit 72 and moved away from the second locking detection unit 72. As the protruded edge 31 at the left side of the transmission rod 30 is correspondingly rotated, the first locking detection unit 71 of the locking detection module 70 is pressed by this protruded edge 31. When the first locking detection unit 71 of the locking detection module 70 is pressed, the first locking detection unit 71 and the second locking detection unit 72 of the locking detection module 70 generate detection signals “1” and “0”, respectively. After the motion detection circuit board 50 receives the detection signals “1” and “0”, the motion detection circuit board 50 judges that the latch bolt 41 protruded in the first direction has reached the locking position (see FIG. 1A(ii)). In this embodiment, the first direction is the left direction.

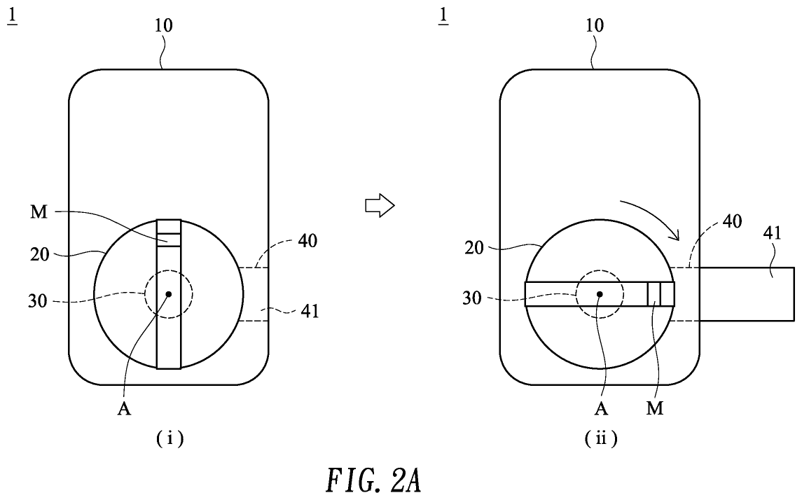

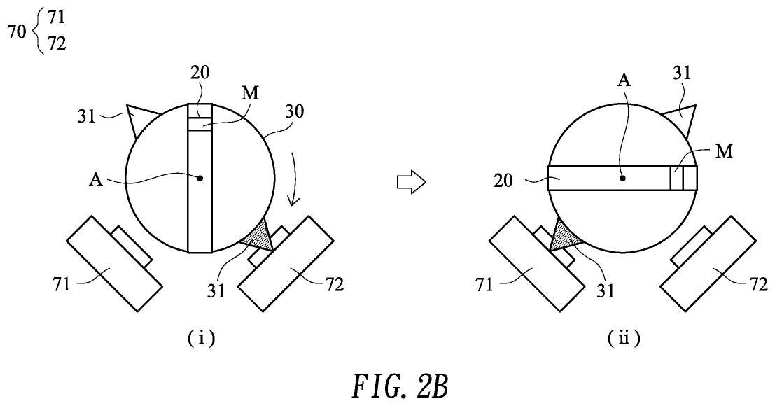

Please refer to FIGS. 2A and 2B. FIG. 2A schematically illustrates the electronic door lock according to the embodiment of the present invention, in which the latch bolt of the electronic door lock is permitted to be protruded in a second direction. FIG. 2B schematically illustrates the operation of the locking detection module of the electronic door lock as shown in FIG. 2A.

In this embodiment, the latch bolt 41 is permitted to be protruded out in the second direction. Consequently, the operating element 20 and the linked transmission rod 30 are rotatable about the rotation axis A in the clockwise direction. In the situation of FIG. 2B(i), the operating element 20 is in the vertical state. Meanwhile, the second locking detection unit 72 of the locking detection module 70 is pressed by the protruded edge 31 at the right side of the transmission rod 30. Moreover, the rotation mark M on the operating element 20 is located at the 12 o'clock position. Under this circumstance, the locking detection module 70 generates detection signals “0” and “1”. After the motion detection circuit board 50 receives the detection signals “0” and “1”, the motion detection circuit board 50 judges that the latch bolt 41 is completely received within the latch assembly 40 (i.e., in the situation of FIG. 2A(i)).

Then, the operating element 20 is rotated in the clockwise direction. Consequently, as shown in FIG. 2B (ii), the rotation mark M on the operating element 20 is rotated to the 3 o'clock position. Under this circumstance, the protruded edge 31 originally contacted with the second locking detection unit 72 is detached from the second locking detection unit 72 and moved away from the second locking detection unit 72. The protruded edge 31 at the right side of the transmission rod 30 is correspondingly rotated, and the first locking detection unit 71 of the locking detection module 70 is pressed by this protruded edge 31. When the first locking detection unit 71 of the locking detection module 70 is pressed, the first locking detection unit 71 and the second locking detection unit 72 of the locking detection module 70 generate detection signals “1” and “0”, respectively. After the motion detection circuit board 50 receives the detection signals “1” and “0”, the motion detection circuit board 50 judges that the latch bolt 41 protruded in the first direction has reached the locking position (i.e., in the situation of FIG. 2A(ii)). In this embodiment, the first direction is the right direction.

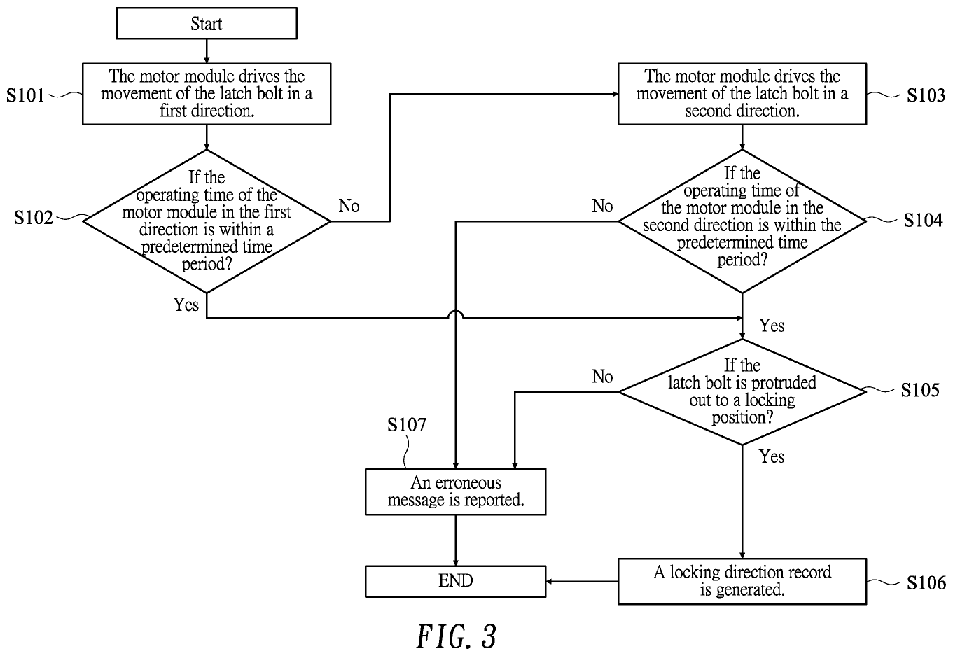

Please refer to FIGS. 1A, 1C, 2A, 2B and 3. FIG. 3 is a flowchart illustrating a method of locking and unlocking an electronic door lock according to an embodiment of the present invention. The locking and unlocking method of FIG. 3 is applied to the electronic door lock 1 that is installed on a door panel.

After the initial installation of the electronic door lock 1 is completed, the motor module 60 drives the movement of the latch bolt 41 in a first direction (Step S101). In the step S101, the motion detection circuit board 50 controls the motor module 60 to drive the movement of the latch bolt 41 in the first direction. In an embodiment, the first direction is a left direction. It is noted that the first direction is not restricted. For example, in another embodiment, the first direction is a right direction.

Then, a step S102 is performed to judge whether the operating time of the motor module 60 in the first direction is within a predetermined time period. In the step S102, the motion detection circuit board 50 judges whether the operating time of the motor module 60 for driving the latch bolt 41 in the first direction is within the predetermined time period. For example, the predetermined time period is in the range between 3 seconds and 7 seconds. If the operating time of the motor module 60 in the first direction is not within the predetermined time period, the judging condition of the step S102 is not satisfied. It means that the latch bolt 41 is unable to be moved in the first direction. Then, a step S103 is performed. That is, the motor module 60 drives the movement of the latch bolt 41 in a second direction.

In the step S103, the motion detection circuit board 50 controls the reverse rotation of the motor module 60, and thus the latch bolt 41 is driven to be moved in the second direction.

Then, a step S104 is performed to judge whether the operating time of the motor module 60 in the second direction is within a predetermined time period. In the step S104, the motion detection circuit board 50 judges whether the operating time of the motor module 60 for driving the latch bolt 41 in the second direction is within the predetermined time period. For example, the predetermined time period is in the range between 3 seconds and 7 seconds. If the operating time of the motor module 60 in the second direction is not within the predetermined time period, the judging condition of the step S104 is not satisfied. It means that the latch bolt 41 is unable to be correctly moved in the second direction. Then, a step S107 is performed to report an erroneous message.

In the step S107, the motion detection circuit board 50 issues the erroneous message and transmits the erroneous message to a main circuit board (not shown) of the electronic door lock 1. In response to the erroneous message, an operation interface of the electronic door lock 1, a display interface, a speaker (not shown) or any other appropriate output device generates an error warning signal to prompt the user that the electronic door lock 1 is unable to work normally because of installation errors or abnormal internal components.

If the judging result of the step S102 or the judging result of the step S104 indicates that the operating time of the motor module 60 is within the predetermined time period, the judging condition of the step S102 or the judging condition of the step S104 is satisfied. It means that the latch bolt 41 can be normally moved in the first direction or the second direction. Then, a step S105 is performed to judge whether the latch bolt 41 is protruded out to a locking position.

If the judging result of the step S105 indicates that the motion detection circuit board 50 receives the detection signals “0” and “1” from the locking detection module 70, it means that the latch bolt 41 cannot be successfully protruded out to the locking position. In other words, the judging condition of the step S105 is not satisfied. This detection result indicates that the latch bolt 41 is able to be normally moved in the first direction or the second direction but unable to reach the locking position. Then, the step S107 of reporting the erroneous message is performed again. Whereas, if the judging result of the step S105 indicates that the motion detection circuit board 50 receives the detection signals “1” and “0” from the locking detection module 70 (e.g., in the situation as shown in FIG. 1C(ii) or FIG. 2B(ii)), it means that the latch bolt 41 has been protruded out to the locking position (e.g., in the situation as shown in FIG. 1A(ii) or FIG. 2A(ii)). In other words, the judging condition of the step S105 is satisfied.

Afterwards, a locking direction record is generated (Step S106). In the step S106, the firmware FW in the motion detection circuit board 50 as shown in FIG. 1B generates the locking direction record about the latch bolt 41 (i.e., the first direction or the second direction). The locking direction record is stored in the motion detection circuit board 50. Subsequently, the locking action or the unlocking action of the electronic door lock 1 will be performed according to the locking direction record.

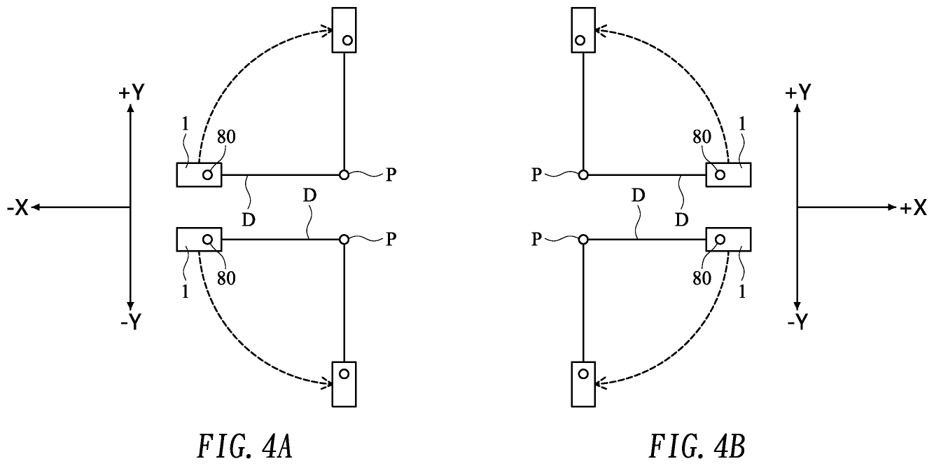

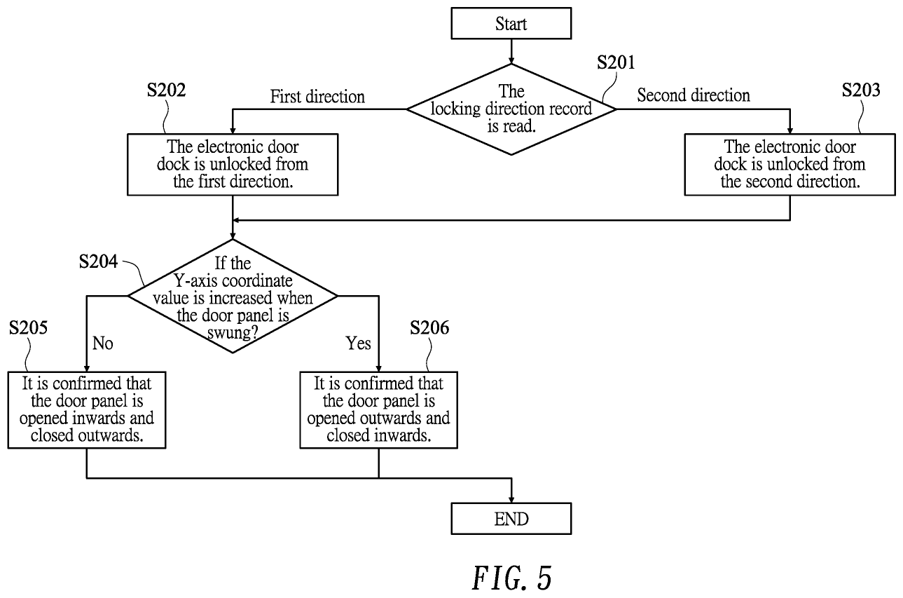

Please refer to FIGS. 4A, 4B and 5. FIGS. 4A and 4B are schematic top views illustrating the operations of the geomagnetic sensing unit in the electronic door lock when the door panel is opened or closed. FIG. 5 is a flowchart illustrating a method of judging the door opening direction by using the electronic door lock of the present invention.

The electronic door lock 1 is installed on the door panel D. The door panel D comprises a door shaft P. Moreover, the door panel D can be swung and shifted relative to the door shaft P. In the example of FIG. 4A, the door panel D is locked or unlocked in the first direction (i.e., the left side of the door panel D). In the example of FIG. 4B, the door panel D is locked or unlocked in the second direction (i.e., the right side of the door panel D). In addition, the geomagnetic sensing unit 80 in the electronic door lock 1 can be used to detect the change of the Y-axis coordinate value of the door panel D.

When the door panel D is closed, the Y-axis coordinate value detected by the geomagnetic sensing unit 80 is defined as “0”. In case that the door panel D is pushed outwardly, the Y-axis coordinate value is increased. In case that the door panel D is pulled back inwardly, the Y-axis coordinate value is decreased. In this embodiment, the geomagnetic sensing unit 80 is installed on the electronic door lock 1. It is noted that the position of the electronic door lock 1 is not restricted. For example, in another embodiment, the electronic door lock 1 is installed on the door panel D and located at any position of the door panel D where the swinging and shifting action can be detected.

After the electronic door lock 1 is unlocked in an electronically controlled method (for example, the electronic door lock 1 is unlocked through the fingerprint recognition or the password of the user's input), the following steps will be performed.

Firstly, in a step S201, the locking direction record is read. Meanwhile, the firmware FW in the motion detection circuit board 50 as shown in FIG. 1B reads the locking direction record that has been generated in the step S106 of FIG. 3. If the locking direction record indicates that the locking direction is the first direction, a step S202 is performed to unlock the electronic door dock 1 from the first direction. Whereas, if the locking direction record indicates that the locking direction is the second direction, a step S203 is performed to unlock the electronic door dock 1 from the second direction.

In the step S202 or the step S203, the motion detection circuit board 50 controls the reverse rotation of the motor module 60 according to the locking direction of the latch bolt 41. Consequently, the latch bolt 41 is retracted back into the latch assembly 40. When the locking detection module 70 issues the detection signals “0” and “1” (i.e., in the situation of FIG. 1C(i) or FIG. 2B(i)), it means that the latch bolt 41 is retracted back and completely received with the latch assembly 40 (i.e., in the situation of FIG. 1A(i) or FIG. 2A(i)).

After the step S202 or the step S203, a step S204 is performed to judge whether the Y-axis coordinate value is increased when the door panel D is swung. If the Y-axis coordinate value detected by the geomagnetic sensing unit 80 is decreased, the judging condition of the step S204 is not satisfied. Then, a step S205 is performed to confirm that the door panel D is opened inwards and closed outward (i.e., in the situation of the lower part of FIG. 4A or FIG. 4B). That is, the door panel D is an inward-opening door. When the door panel D is pulled inwards, the door panel is opened. When the door panel D is pushed, the door panel D is closed. Whereas, if the Y-axis coordinate value detected by the geomagnetic sensing unit 80 is increased, the judging condition of the step S204 is satisfied. Then, a step S206 is performed to confirm that the door panel D is opened outwards and closed inwards (i.e., in situation of the upper part of FIG. 4A or FIG. 4B). That is, the door panel D is an outward-opening door. When the door panel D is pushed outwards, the door panel is opened. When the door panel D is pulled back, the door panel D is closed.

In the step S205 and the step S206, the information about the detected Y-axis coordinate value is transmitted from the geomagnetic sensing unit 80 to the motion detection circuit board 50. According to the information about the detected Y-axis coordinate value, the motion detection circuit board 50 generates a prompt signal through the operation interface of the electronic door lock 1, the display interface, the speaker or any other appropriate output device. In response to the prompt signal, the user can realize the way of opening or closing the door panel D.

From the above descriptions, the present invention provides the electronic door lock. When compared with the conventional technologies, the latch bolt in the electronic door lock of the present invention can be driven to be moved in two different directions. Consequently, the electronic door lock is suitably applied to the door panel opened/closed to the left side or the door panel opened/closed to the right side. Furthermore, the geomagnetic sensing unit installed on the electronic door lock or the door panel is used to detect the opening/closing direction of the door panel in order to prompt the user of the opening/closing direction of the door panel. In other words, the technologies of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. An electronic door lock installed on a door panel, the electronic door lock comprising:
a latch assembly comprising a latch bolt;
a lock body;
a transmission rod disposed within the lock body, and connected with the latch assembly, wherein the transmission rod comprises a first protruded edge and a second protruded edge;
a locking detection module comprising a first locking detection unit and a second locking detection unit corresponding to the first protruded edge and the second protruded edge;
a motor module installed in the lock body, wherein the transmission rod is driven by the motor module; and
a motion detection circuit board electrically connected with the motor module and the locking detection module,
wherein when the latch bolt is completely received within the latch assembly, the first protruded edge is contacted with the second locking detection unit, wherein when the motion detection circuit board controls the motor module to drive rotation of the transmission rod and the latch bolt is correspondingly protruded out from the latch assembly to a locking position, the first protruded edge is detached from the second locking detection unit, and the first protruded edge or the second protruded edge is correspondingly moved and then contacted with the first locking detection unit, wherein the motion detection circuit board confirms that the latch bolt has been protruded out from the latch assembly according to a detection result of the locking detection module.

2. The electronic door lock according to claim 1, wherein the locking detection module is a micro switch module.

3. The electronic door lock according to claim 1, wherein the electronic door lock further comprises a geomagnetic sensing unit, and an opening direction and a closing direction of the door panel are detected by the geomagnetic sensing unit.

4. The electronic door lock according to claim 1, wherein the lock body comprises an operating element, and the operating element is installed on a surface of the lock body and linked with the transmission rod.

5. A method for automatically judging a locking/unlocking direction of an electronic door lock, the electronic door lock being installed on a door panel, the method comprising steps of:
(A) controlling a motor module to drive a movement of a latch bolt in a first direction;
(B) judging whether an operating time of the motor module in the first direction is within a predetermined time period, wherein if a judging condition of the step (B) is not satisfied, a step (C) is performed, wherein if the judging condition of the step (B) is satisfied, a step (E) is performed;
(C) controlling the motor module to drive the movement of the latch bolt in a second direction;
(D) judging whether an operating time of the motor module in the second direction is within the predetermined time period, wherein if a judging condition of the step (D) is not satisfied, a step (G) is performed, wherein if the judging condition of the step (D) is satisfied, the step (E) is performed;
(E) judging whether the latch bolt is protruded to a locking position, wherein if a judging condition of the step (E) is not satisfied, the step (G) is performed, wherein if the judging condition of the step (E) is satisfied, a step (F) is performed;
(F) generating a locking direction record; and
(G) reporting an erroneous message.

6. The method according to claim 5, wherein the electronic door lock further comprises a geomagnetic sensing unit, and a change of a Y-axis coordinate value of the door panel is detected by the geomagnetic sensing unit, wherein the method further comprises a process of judging a door opening direction, and the process of judging the door opening direction comprises steps of:
(H) reading the locking direction record, wherein if the locking direction record indicates that the electronic door lock is locked in the first direction, a step (I) is performed, wherein if the locking direction record indicates that the electronic door lock is locked in the second direction, a step (J) is performed;
(I) unlocking the electronic door lock from the first direction;
(J) unlocking the electronic door lock from the second direction;
(K) judging whether the Y-axis coordinate value is increased or decreased when the door panel is swung, wherein if the Y-axis coordinate value is decreased, a step (L) is performed, wherein if the Y-axis coordinate value is decreased, a step (M) is performed;
(L) confirming that the door panel is opened inwards and closed outwards; and
(M) confirming that the door panel is opened outwards and closed inwards.

7. The method according to claim 5, wherein in the step (B) and the step (D), the predetermined time period is in the range between 3 seconds and 7 seconds.
